(19) United States
(12) Patent Application Publication
(10) Pub. No.: US 2026/0181661 A1
(43) Pub. Date: Jun. 25, 2026

(54) COMMUNICATION APPARATUS, METHOD FOR CONTROLLING COMMUNICATION, AND STORAGE MEDIUM

(71) Applicant: CANON KABUSHIKI KAISHA, Tokyo (JP)

(72) Inventor: MASAKAZU TSUCHIHASHI, Kanagawa (JP)

(21) Appl. No.: 19/539,783

(22) Filed: Feb. 13, 2026

Related U.S. Application Data
(63) Continuation of application No. PCT/JP2024/027925, filed on Aug. 5, 2024.

(30) Foreign Application Priority Data
Aug. 15, 2023 (JP) 2023-132240

(51) Int. Cl. H04W 72/23; H04W 8/00; H04W 72/20; H04W 72/21

(52) U.S. Cl. CPC H04W 72/23; H04W 8/005; H04W 72/20; H04W 72/21

(57) ABSTRACT

A communication apparatus includes a first acquisition unit configured to acquire type information enabling determination as to whether another communication apparatus is an Integrated Access and Backhaul (IAB) node of a first type involving mobility, a storage unit configured to store generated or acquired area information about an area where the IAB node of the first type provides service, a determination unit configured to determine whether to notify the other communication apparatus of the area information based on the type information on the other communication apparatus, and a transmission unit configured to transmit the area information to the other communication apparatus based on a determination result of the determination unit.

### CROSS-REFERENCE TO RELATED APPLICATIONS

This application is a Continuation of International Patent Application No. PCT/JP2024/027925, filed Aug. 5, 2024, which claims the benefit of Japanese Patent Application No. 2023-132240, filed Aug. 15, 2023, both of which are hereby incorporated by reference herein in their entirety.

### BACKGROUND

### Field of the Technology

The present disclosure relates to a communication apparatus, a method for controlling communication, and a storage medium.

### Description of the Related Art

In the Third Generation Partnership Project (3GPP)®, standardization of Integrated Access and Backhaul (IAB) as a backhaul communication technique is underway.

The IAB technique is a technique that simultaneously uses millimeter-wave wireless communication in a 28 GHz band or the like that is used for access communication between a base station and a User Equipment (UE) as backhaul communication (see Japanese Unexamined Patent Application Publication (Translation of PCT Application) No. 2019-534625).

In the backhaul communication using the IAB technique, a relay device called an IAB node relays communication from an IAB donor that is a base station, via millimeter-wave communication. By using the IAB technique, it is possible to widen area coverage at a low cost compared to conventional wired communication such as optical fiber.

Up to Release 17 (Rel-17 ), 3GPP® has been formulating specifications for a fixed base station (IAB node not involving mobility).

Currently, 3GPP® plans to actively discuss a vehicle mounted relay that will be a use case in upcoming Release 18 (Rel-18) and a Mobile IAB node to formulate specifications to realize the use case. The Mobile IAB node is also referred to as Mobile Base Station Relay (MBSR) and is also referred to as MBSR in the following description.

In this context, it is conceivable that various requirements will arise that cannot be satisfied only by the specifications assuming a fixed base station discussed so far.

Among them, there is a discussion item “permission and settings of Mobile Base Station Relay”. In the discussion item, it is assumed that an MBSR temporarily mounted on a vehicle functions as a relay and provides service to a UE in order to realize special coverage and connection during a large-scale event in an urban environment or a specified area.

A range where the MBSR can operate as a relay is referred to as a permitted area, and is managed by a Core Network (CN). In a case where the MBSR is present in a permitted area, the MBSR provides service to surrounding UEs, and in a case where the MBSR moves outside a permitted area, the MBSR suspends provision of the service.

In this regard, a technique for providing service by using position information and movement information on a mobile node is known (Japanese Unexamined Patent Application Publication (Translation of PCT Application) No. 2009-501453).

At this moment, definition of the permitted area information and a method for notifying the permitted area information to the MBSR are not standardized. If the permitted area information can be notified to the MBSR, the MBSR can compare position information of the MBSR and the permitted area information and determine whether the service can be provided.

### SUMMARY

The present disclosure has been made in view of at least one of the above described issues. One aspect of the present disclosure is directed to providing a mechanism that can efficiently notify permitted area information to a Mobile Base Station Relay (MBSR).

According to an aspect of the present disclosure, a communication apparatus includes a first acquisition unit configured to acquire type information enabling determination as to whether another communication apparatus is an Integrated Access and Backhaul (IAB) node of a first type involving mobility, a storage unit configured to store generated or acquired area information about an area where the IAB node of the first type provides service, a determination unit configured to determine whether to notify the other communication apparatus of the area information based on the type information on the other communication apparatus, and a transmission unit configured to transmit the area information to the other communication apparatus based on a determination result of the determination unit.

Features of the present disclosure will become apparent from the following description of embodiments with reference to the attached drawings.

### BRIEF DESCRIPTION OF THE DRAWINGS

FIG. 1 is a block diagram of hardware constituting a base station.

FIG. 2 is a software function block diagram of a base station according to a first embodiment.

FIG. 3 illustrates a sequence at initial connection according to the first embodiment.

FIG. 4A is a first exemplary diagram of a communication permitted area format according to the first embodiment.

FIG. 4B is a second exemplary diagram of the communication permitted area format according to the first embodiment.

FIG. 4C is a third exemplary diagram of the communication permitted area format according to the first embodiment.

FIG. 4D is a fourth exemplary diagram of the communication permitted area format according to the first embodiment.

FIG. 5 is a flowchart of initial connection processing by the base station according to the first embodiment.

FIG. 6A is a software function block diagram of a base station according to a second embodiment.

FIG. 6B illustrates a sequence at initial connection according to the second embodiment.

FIG. 6C is a flowchart of initial connection processing by the base station according to the second embodiment.

FIG. 7 illustrates a sequence at general connection reconfiguration based on a Third Generation Partnership Project (3GPP)® standard.

FIG. 8 is a flowchart of connection reconfiguration processing by a base station according to a third embodiment.

### DESCRIPTION OF THE EMBODIMENTS

### First Embodiment

Each embodiment is described in detail below with reference to the accompanying drawings. In the following description, “number ***” in TS *** represents a number in Technical Specification in the Third Generation Partnership Project (3GPP)® standard.

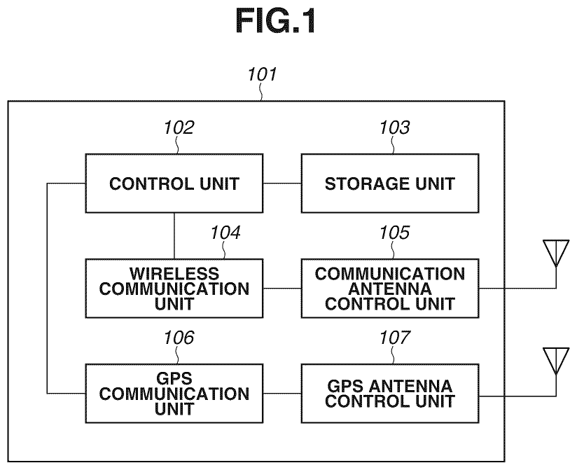

FIG. 1 is a block diagram illustrating an example of a hardware configuration of an Integrated Access and Backhaul (IAB) donor (hereinafter, also referred to as a “gNB”) that is a base station according to a first embodiment.

A hardware configuration 101 includes a control unit 102, a storage unit 103, a wireless communication unit 104, a communication antenna control unit 105, a global positioning system (GPS) communication unit 106, and a GPS antenna control unit 107.

The control unit 102 controls the entire apparatus by executing a control program stored in the storage unit 103. The control unit 102 includes one or more processors such as a central processing unit (CPU) or a microprocessor unit (MPU), and controls the entire communication apparatus by executing the control program read out to a random access memory (RAM) that is the storage unit 103. Processing performed by the control unit 102 described in a flowchart described below can also be implemented using a hardware circuit such as an application-specific integrated circuit (ASIC) or a field programmable gate array (FPGA). Further, the processing described in the flowchart described below can also be implemented by the hardware circuit in conjunction with the processors such as the CPU and the MPU.

The storage unit 103 stores the control program executed by the control unit 102, and various kinds of information such as cell information, connected terminal information, IAB routing information, and position information. The storage unit 103 may include a main storage unit and an auxiliary storage unit. Examples of the main storage unit include a read only memory (ROM) and a RAM. The main storage unit may store or temporarily store operating system (OS) that is basic software to be executed by the control unit 102, programs such as application software, and data. Examples of the auxiliary storage unit include a hard disk drive (HDD) and a solid state drive (SSD), and the auxiliary storage unit may store data relating to the application software and the like. For example, the control program stored in a non-volatile storage area are loaded into a RAM and executed by the processor included in the control unit 102. In this manner, the control unit 102 and the storage unit 103 may function as a computer.

The wireless communication unit 104 performs cellular network communication such as Long Term Evolution (LTE) or Fifth Generation (5G) in compliance with 3GPP® standards. Note that, while 5G is described, the present embodiment is also applicable to cellular network communication other than 5G, such as 5G Advanced and Sixth Generation (6G).

The communication antenna control unit 105 controls an antenna (not illustrated) for wireless communication performed by the wireless communication unit 104.

The GPS communication unit 106 receives a satellite signal from a GPS satellite, and acquires position information on a current position including position identification information such as longitude and latitude information, and current time information. Further, the GPS communication unit 106 may have a function to measure (perform positioning of) the current position based on the satellite signal. In place of or in addition to GPS, another global navigation satellite system (GNSS) may be used.

The GPS antenna control unit 107 controls an antenna (not illustrated) for GPS communication performed by the GPS communication unit 106.

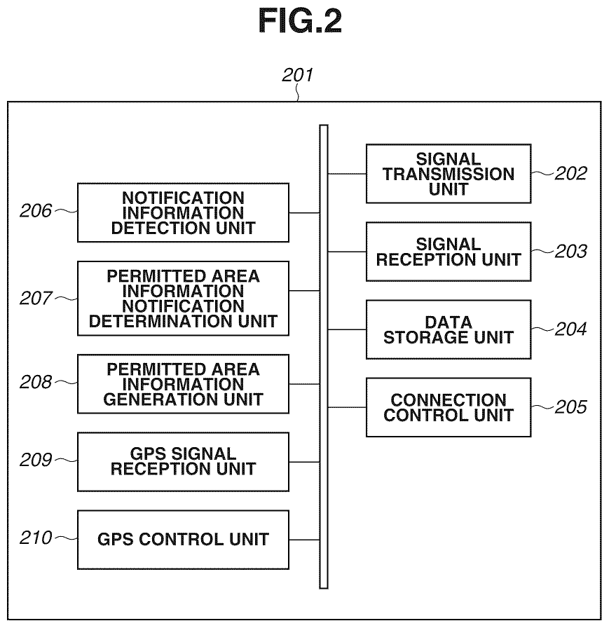

FIG. 2 is a block diagram illustrating an example of a configuration of software functional blocks of the base station that executes a communication control function according to the present embodiment.

A software function 201 includes a signal transmission unit 202, a signal reception unit 203, a data storage unit 204, a connection control unit 205, a notification information detection unit 206, a permitted area information notification determination unit 207, and a permitted area information generation unit 208. The software function 201 further includes a GPS signal reception unit 209, and a GPS control unit 210.

The signal transmission unit 202 and the signal reception unit 203 perform cellular network communication such as LTE or 5G in compliance with the 3GPP® standards, with a terminal apparatus. A control plane signal is received by the signal reception unit 203. The cellular network communication performed by the signal transmission unit 202 and the signal reception unit 203 include communication at a Radio Access Network (RAN) layer of 5G New Radio (NR) and LTE. Further, the cellular network communication performed by the signal transmission unit 202 and the signal reception unit 203 may include various kinds of communication for providing the cellular network communication, such as communication at a Radio Resource Control (RRC) layer that is an upper layer.

In the present embodiment, in a case where the permitted area information notification determination unit 207 described below determines that permitted area information is to be notified to an opposite communication apparatus (another communication apparatus), the signal transmission unit 202 transmits the permitted area information to the opposite communication apparatus. A method of transmitting the permitted area information and the like are described below.

Further, in the present embodiment, the signal reception unit 203 acquires information that enables determination as to whether the opposite communication apparatus is an IAB node of a type involving mobility. In other words, the signal reception unit 203 acquires information that enables determination as to whether the opposite communication apparatus is a Mobile Base Station Relay (MBSR). Such information is optional and may be, for example, information that explicitly or implicitly indicates that the communication apparatus is an MBSR, or information that explicitly or implicitly indicates that the communication apparatus is not an MBSR. In the present embodiment, such information is IAB node type information, and details thereof are described below.

The data storage unit 204 stores and holds software, IAB routing information, information about connected terminals, current time information, position information, movement path information, and the like.

The connection control unit 205 controls the antenna for wireless communication performed by the wireless communication unit 104.

The notification information detection unit 206 detects notification information from surrounding base stations and MBSRs.

The permitted area information notification determination unit 207 determines whether to notify the opposite communication apparatus of permitted area information.

The permitted area information generation unit 208 generates permitted area information to be notified to the opposite communication apparatus, and stores the permitted area information in a predetermined storage area such as the data storage unit 204. The predetermined storage area functions as a storage unit for storing the permitted area information. Note that the permitted area information generation unit 208 may acquire the permitted area information from outside or the like in place of or in addition to generating the permitted area information, and store the permitted area information in the predetermined storage area. For example, the permitted area information may be generated by a Core Network (CN), or may be generated by a gNB 300 based on information received from the CN. In a case where the permitted area information is generated by the CN, for example, the CN may generate permitted area information about a permitted area around the gNB 300, or permitted area information about a permitted area closest to the gNB 300, among all permitted areas managed by the CN. The actual predetermined storage area may be a storage area in the RAM or a storage area in the auxiliary storage unit.

The GPS signal reception unit 209 performs communication in compliance with GPS standards. The GPS control unit 210 controls the antenna for GPS communication performed by the GPS communication unit 106, and calculates the current position and a time from received GPS information. Further, the GPS control unit 210 outputs information in a format such as National Marine Electronics Association (NMEA)-0183, and stores the current position and the time in the data storage unit 204 as necessary.

Subsequently, a method for notifying permitted area information according to the present embodiment is described.

In the first embodiment, a method for notifying the permitted area information based on IAB node type information received from an MBSR by using a general initial connection sequence in the 3GPP® standard is described. The IAB node type information and the permitted area information are transmitted and received using a control plane signal of a 5G system. As a specific control plane signal, a Radio Resource Control (RRC) message is used. More specifically, an RRCSetupComplete message is used for the IAB node type information, and an RRCReconfiguration message is used for the permitted area information.

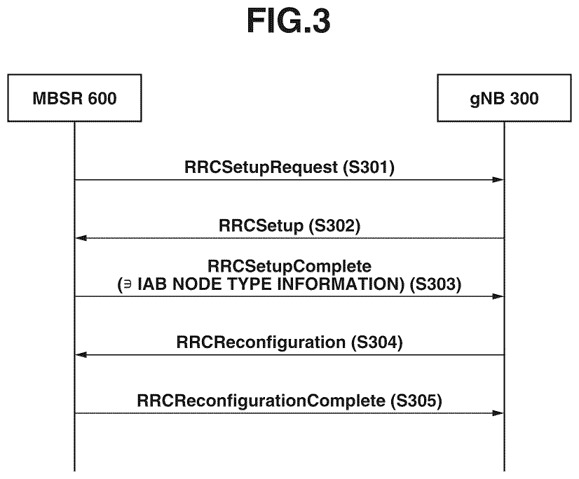

FIG. 3 illustrates an initial connection sequence according to the present embodiment based on a general initial connection sequence in the 3GPP® standards. In addition to the MBSR, a fixed IAB node and a User Equipment (UE) are also connected to the 5G system via a base station (gNB) based on the sequence.

In step S301, an MBSR 600 transmits an RRCSetupRequest message as a connection request to the gNB 300.

In a case where connection from the MBSR 600 is permitted, in step S302, the gNB 300 having received the message transmits an RRCSetup message to the MBSR 600.

In step S303, the MBSR 600 having received the message transmits an RRCSetupComplete message as a connection completion notification to the gNB 300. At this time, the MBSR 600 includes information called Mobile IAB Indication in the RRCSetupComplete message. The information indicates whether the MBSR 600 is an MBSR (Mobile IAB), and is planned to be standardized in Release 18. In the present embodiment, the gNB 300 determines whether the opposite communication apparatus is an MBSR by checking whether the information is included in the RRCSetupComplete message.

After RRC connection is established between the MBSR 600 and the gNB 300, RRC reconfiguration processing of the MBSR 600 is performed.

In step S304, the gNB 300 transmits an RRCReconfiguration message to the MBSR 600. In the present embodiment, in a case where it is determined that the opposite communication apparatus is an MBSR, the gNB 300 includes permitted area information in the RRCReconfiguration message. Details of the permitted area information are described below. The MBSR 600 having received the message performs the RRC reconfiguration processing based on information included in the RRCReconfiguration message, and determines whether to provide a service to a UE based on the permitted area information and the position information of the MBSR 600.

After the reconfiguration processing is completed, in step S305, the MBSR 600 transmits an RRCReconfigurationComplete message.

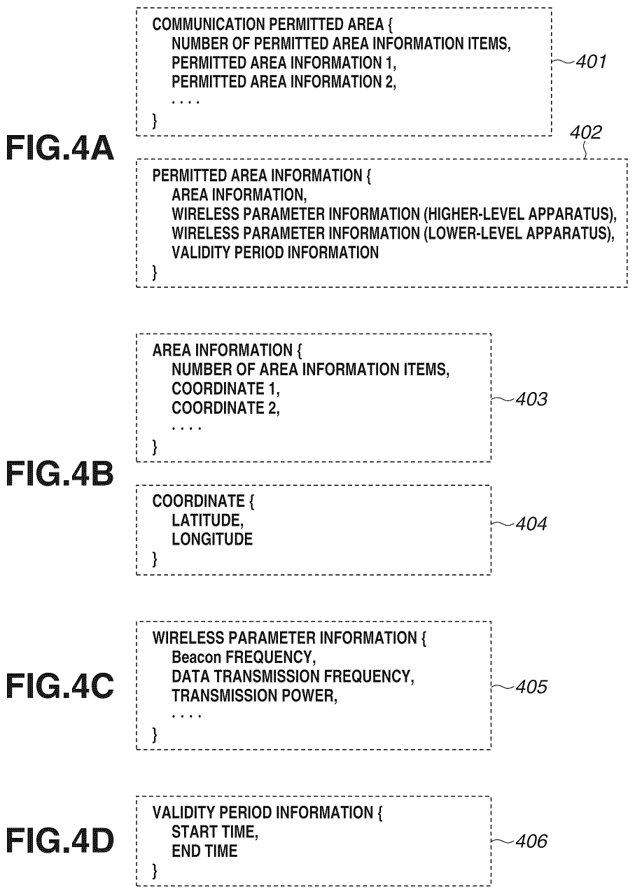

FIGS. 4A to 4D illustrate various kinds of examples of a communication permitted area format 301 included in each of the RRCSetup message and the RRCReconfiguration message.

FIG. 4A illustrates an example of a communication permitted area format 401. The communication permitted area format 401 is a fundamental format that indicates a communication permitted area where the MBSR is operable.

The information may be incorporated as a new field into an RRCReconfiguration message field or an RRCSetup message field as specified in TS 38.331. The information is notified to the MBSR.

The communication permitted area includes the number of permitted area information items and permitted area information.

The number of permitted area information items stores the number of permitted area information items included in the message.

The permitted area information is stored in a number corresponding to the number of permitted area information items, such as permitted area information 1, permitted area information 2, and so on. The MBSR can provide the service in a single permitted area or a plurality of permitted areas indicated by the permitted area information. In this embodiment, while one permitted area information item is information about one permitted area, one permitted area information item may be information about two or more permitted areas. Further, the unit of a permitted area may be a set of physically continuous regions. Furthermore, the permitted areas may be separated whenever any one of wireless parameter information (higher-level apparatus), wireless parameter information (lower-level apparatus), and validity period information described blow is different.

In this embodiment, the service provided by the MBSR within the permitted area includes, for example, various kinds of communication services provided by an IAB node to a UE. In this case, the concept of communication service includes forming a state where access from a UE can be accepted.

In the example illustrated in FIG. 4A, a permitted area information format 402 is a configuration example of the permitted area information 1. The permitted area information 2 and the like may be similarly configured.

The permitted area information 1 includes area information, wireless parameter information (higher-level apparatus), wireless parameter information (lower-level apparatus), and validity period information.

FIG. 4B illustrates an example of area information 403. In the example illustrated in FIG. 4B, the area information 403 includes the number of area information items and coordinates.

In the number of area information items, the number of coordinate points forming a coordinate group included in the message is stored.

One coordinate point includes latitude and longitude information (a pair of coordinates) as illustrated in a format 404. Next, the format 404 will be described. The latitude and longitude information stored in the format 404 may be coded in 24 bits in accordance with a coordinate information representation format specified in TS 23.032.

Such a coordinate point is stored in a number corresponding to the number of area information items. An area obtained by connecting such coordinate points may be handled as the communication permitted area where the MBSR can operate.

FIG. 4C illustrates an example of a wireless parameter information format 405. The wireless parameter information format 405 relates to the wireless parameter information (higher-level apparatus) and the wireless parameter information (lower-level apparatus) of the permitted area information format 402. The wireless parameter information (higher-level apparatus) and the wireless parameter information (lower-level apparatus) of the permitted area information format 402 each indicate wireless parameters when the MBSR is operated within an associated communication permitted area.

In the wireless parameter information format 405, various kinds of parameters relating to wireless settings are stored. The various kinds of parameters relating to wireless settings suitably include a beacon frequency, a data transmission frequency, and transmission power, but are not limited thereto.

Setting values of the various kinds of parameters relating to wireless settings are used for settings for wireless operation of the MBSR. More specifically, wireless settings set to the wireless parameter information (higher-level apparatus) is applied to wireless settings for an apparatus serving as a higher-level apparatus of the MBSR. The apparatus serving as the higher-level apparatus of the MBSR may be a gNB or the like. Further, wireless settings set to the wireless parameter information (lower-level apparatus) is applied to wireless settings for an apparatus serving as a lower-level apparatus of the MBSR. The apparatus serving as the lower-level apparatus of the MBSR may be a UE or the like.

As the examples of the various kinds of parameters relating to wireless settings, the beacon frequency, the data transmission frequency, and the transmission power are described, but the various kinds of parameters relating to wireless settings are not limited thereto. For example, the various kinds of parameters relating to wireless settings may include a SL-V2X-Preconfiguration parameter, a SL-PreconfigurationNR parameter, and the like specified in TS 36.331. In place of or in addition to the SL-PreconfigurationNR parameter, a wireless parameter for the MBSR that will be newly provided in the future may be used.

The validity period information includes a start time and an end time as denoted by a reference numeral 406 in FIG. 4D. A time when the permitted area associated with the validity period information becomes valid is set by this information. As a setting method, for example, the time may be set as a character string of YYYY-MM-DD HH:MM:SS, or may be set in accordance with a time information format used in System Information Block (SIB) 9 as specified in TS 38.331.

Thus far, specific examples of the communication permitted area format have been described above; however, other forms are also possible. For example, the wireless parameter information (higher-level apparatus), the wireless parameter information (lower-level apparatus), and the validity period information included in the permitted area information indicated by the permitted area information format 402 may be optional information in the format. Further, in a case where wireless settings associated with the set permitted area is not particularly necessary, this field may not be included. Further, also in a case where a validity period of the permitted area is not necessary, this field may not be included.

Next, processing in which the gNB 300 notifies the permitted area information is described using a flowchart.

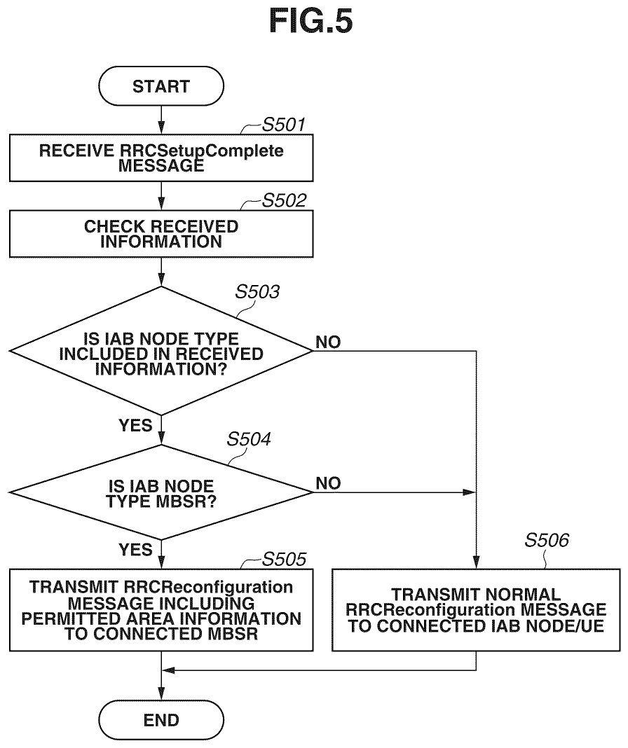

FIG. 5 illustrates a flow of initial connection processing by the gNB 300 according to the present embodiment.

In step S501, the gNB 300 receives an RRCSetupComplete message transmitted by the MBSR 600.

In step S502, the gNB 300 analyzes the received RRCSetupComplete message, and checks information included in the message.

In step S503, the gNB 300 checks whether an IAB node type is included in the received information. In the present embodiment, the gNB 300 checks presence or absence of the Mobile IAB Indication. In a case where the IAB node type is not included therein (NO in step S503), the processing proceeds to step S506. In step S506, a normal RRCReconfiguration message not including the permitted area information is transmitted to the opposite communication apparatus, and the processing then ends. In contrast, in a case where the IAB node type is included therein (YES in step S503), the processing proceeds to step S504.

In step S504, the gNB 300 determines whether the IAB node type is an MBSR. In the present embodiment, in a case where a value of the Mobile IAB Indication is True, it is determined that the IAB node type is the MBSR. In a case where the IAB node type is not the MBSR (NO in step S504), the processing proceeds to step S506. In step S506, a normal RRCReconfiguration message not including the permitted area information is transmitted to the opposite communication apparatus, and the processing then ends. In a case where the IAB node type is the MBSR (YES in step S504), the processing proceeds to step S505.

In step S505, the gNB 300 generates an RRCReconfiguration message including the permitted area information, and transmits the RRCReconfiguration message to the opposite communication apparatus.

In the present embodiment, it is determined whether the opposite communication apparatus is an MBSR based on the IAB node type information included in the RRCSetupComplete message. Then, the base station that notifies the permitted area information using the RRCReconfiguration message only in the case of an MBSR has been described. Note that the RRC message for notifying the permitted area information does not necessarily have to be the RRCReconfiguration message. For example, the permitted area information can be notified to the MBSR by the permitted area information being included in the RRCSetup message. In this case, the method for acquiring the IAB node type does not necessarily have to be the RRCSetupComplete message. For example, information enabling determination as to whether the opposite communication apparatus is the MBSR may be included in an RRCSetupRequest message or notification information in System Information Block (SIB) 1.

However, in a method in which, as a means for notifying the permitted area information by the base station to the MBSR, the control plane signal in the 5G system is simply used as described above, the following issue arises. More specifically, the above-described initial connection sequence is also used by a fixed IAB node and a UE other than the MBSR. In a case where the permitted area information is added to an existing RRC message, the permitted area information is also notified to a fixed IAB node and a UE that do not require the permitted area information.

In contrast, according to the present embodiment, as described above, the gNB 300 can determine whether the opposite communication apparatus is the MBSR based on the IAB node type information acquired via the control plane signal. Accordingly, it is possible to reduce a possibility that the permitted area information is notified to the fixed IAB node and the UE that do not require the permitted area information. As a result, an information processing load and a communication load inherently caused by unnecessary notification (notification to a fixed IAB node and a UE) can be substantially eliminated. In this manner, according to the present embodiment, a mechanism capable of efficiently notifying the MBSR of the permitted area information can be provided.

### Second Embodiment

In the first embodiment, the base station that determines whether to notify the permitted area information based on the IAB node type information included in the RRCSetupComplete message has been described. In this context, the permitted area information notified by a single base station has identical content for all MBSRs. However, unlike the fixed IAB node, the MBSR can freely move. Depending on operation of the MBSR, such as moving at a speed higher than expected, the notified permitted area information may become insufficient. Thus, a method for acquiring status information such as a moving speed and a moving direction from the MBSR and changing the permitted area information to be notified based on a status of the MBSR is described. This makes it possible to provide the permitted area information optimum to each MBSR.

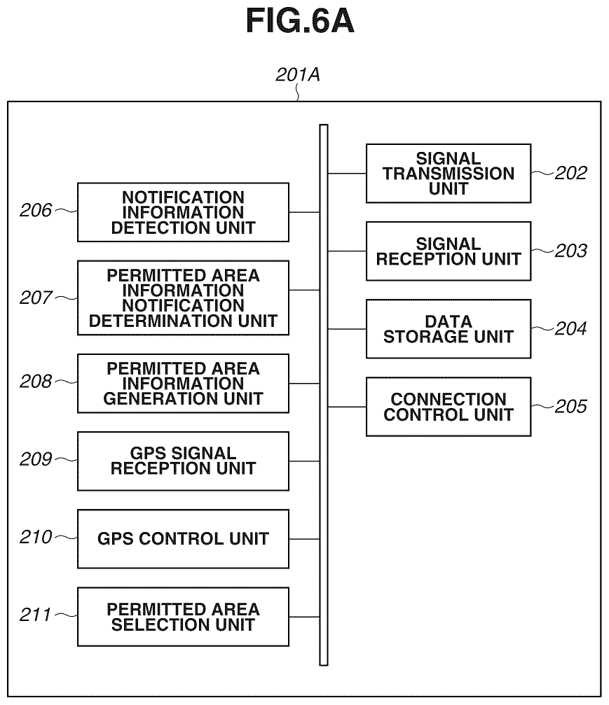

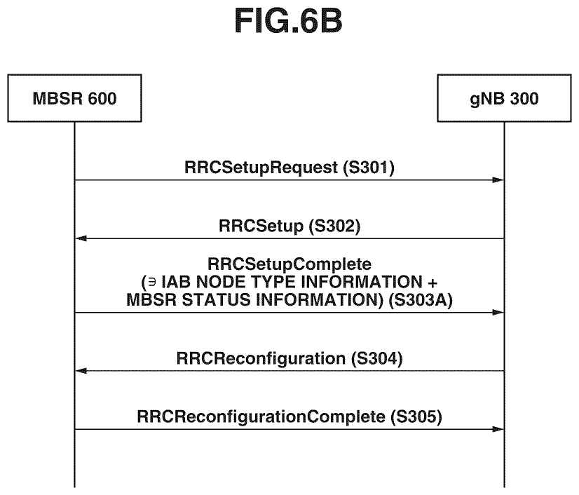

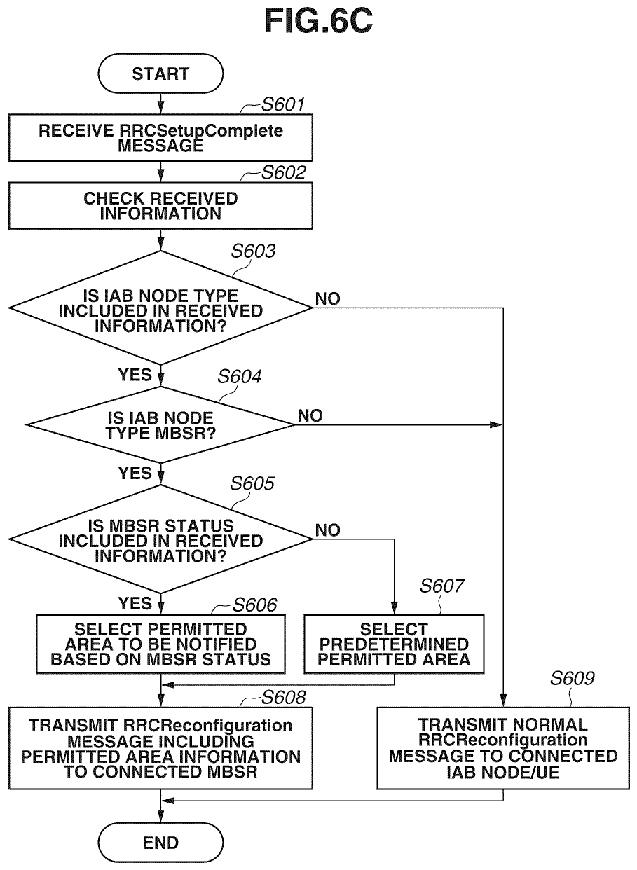

FIG. 6A is a block diagram illustrating an example of a configuration of software functional blocks of a base station that performs a communication control function according to the present embodiment.

A software function 201A according to the present embodiment is different from the software function 201 (FIG. 2) according to the above-described first embodiment in that a permitted area selection unit 211 is added.

The permitted area selection unit 211 selects, from an area group, a permitted area to be notified to the MBSR 600. The area group refers to a set of multiple permitted areas where the MBSR can provide service. In other words, the permitted area where the MBSR can provide service is not limited to one permitted area and may be multiple permitted areas. In this case, the permitted area selection unit 211 selects a permitted area where each MBSR can provide service from the multiple permitted areas (area group). Note that, as a permitted area where one MBSR can provide service, one permitted area is typically selected, but two or more permitted areas may be selected.

In the present embodiment, the permitted area information generation unit 208 generates or acquires area information about the permitted area to be notified, selected by the permitted area selection unit 211. For example, the permitted area information generation unit 208 may generate the area information about the permitted area to be notified based on area group information that may be acquired from the CN. In this case, the area group information may be a set of permitted area information about multiple permitted areas. In this context, the multiple permitted areas may be multiple permitted areas belonging to a relatively wide range, or may be a predetermined number of adjacent permitted areas or fewer. Further, in a case where the area group information is generated by the CN, for example, the multiple permitted areas may be all permitted areas managed by the CN. In any case, the generated or acquired permitted area information is stored in a predetermined storage area such as the data storage unit 204 managed by the permitted area information generation unit 208.

A sequence of processing according to the present embodiment is described with reference to FIG. 6B.

Steps S301 and S302 are similar to the steps according to the first embodiment described above with reference to FIG. 3, and accordingly, description thereof is omitted.

In step S303A, the MBSR 600 transmits an RRCSetupComplete message to the gNB 300. At this time, the MBSR 600 includes Mobile IAB Indication as the IAB node type information and information indicating the status of the MBSR in the RRCSetupComplete message. Hereinafter, the information indicating the status of the MBSR is also referred to as “MBSR status information”. Examples of the status of the MBSR include a current position, a movement speed, a movement direction, a stop time, a scheduled stop time, a planned movement path, and an operation route of the MBSR.

In the present embodiment, the permitted area information to be notified is generated based on the MBSR status information. In step S304, the generated permitted area information is notified by an RRCReconfiguration message, as in the first embodiment. In step S305, the MBSR 600 having received the message transmits an RRCReconfigurationComplete message.

Next, processing when the gNB 300 notifies the permitted area information is described with reference to a flowchart.

FIG. 6C illustrates a flow of initial connection processing by the gNB 300 according to the present embodiment.

In step S601, the gNB 300 receives an RRCSetupComplete message transmitted by the MBSR 600.

In step S602, the gNB 300 analyzes the received RRCSetupComplete message, and checks information included in the message.

In step S603, the gNB 300 checks whether an IAB node type is included in the received information. In the present embodiment, the gNB 300 checks presence or absence of Mobile IAB Indication. In a case where the IAB node type is not included in the received information (NO in step S603), the processing proceeds to step S609. In step S609, a normal RRCReconfiguration message not including the permitted area information is transmitted to the opposite communication apparatus, and the processing then ends. In a case where the IAB node type is included therein (YES in step S603), the processing proceeds to step S604.

In step S604, the gNB 300 determines whether the IAB node type is an MBSR. In the present embodiment, in a case where a value of Mobile IAB Indication is True, it is determined that the IAB node type is the MBSR. In this case (YES in step S604), the processing proceeds to step S605. In a case where the IAB node type is not the MBSR (NO in step S604), the processing proceeds to step S609. In step S609, a normal RRCReconfiguration message not including the permitted area information is transmitted to the opposite communication apparatus, and the processing then ends.

In step S605, the gNB 300 checks whether MBSR status information is included in the received information. In a case where MBSR status information is included in the received information (YES in step S605), the processing proceeds to step S606. In step S606, the permitted area selection unit 211 selects permitted area information to be notified to the MBSR, based on the status of the MBSR. For example, selecting a permitted area present in the moving direction of the MBSR, selecting a permitted area farther away in a case where the moving speed of the MBSR is high, and selecting a permitted area along a planned movement path or an operation route may be considered. After the permitted area to be notified is selected, the processing proceeds to step S608. In a case where the MBSR status information is not included therein (NO in step S605), the processing proceeds to step S607. In step S607, predetermined permitted area information is selected, and the processing proceeds to step S608.

In step S608, the gNB 300 generates an RRCReconfiguration message including the permitted area information selected in step S606 or S607, and transmits the RRCReconfiguration message to the opposite communication apparatus.

### Third Embodiment

In the first and second embodiments, the method for notifying the permitted area information by using the initial connection sequence is described.

The RRCReconfiguration message is used to notify the permitted area information, but the message is notified from the base station also at times other than the initial connection. For example, the message is notified when the MBSR moves and a connection destination is changed to another base station. In a third embodiment, a method for updating and notifying the permitted area information by using a sequence when the MBSR moves and is connected to another base station is described.

Further, in the present embodiment, updating the MBSR status information used in the second embodiment is also described.

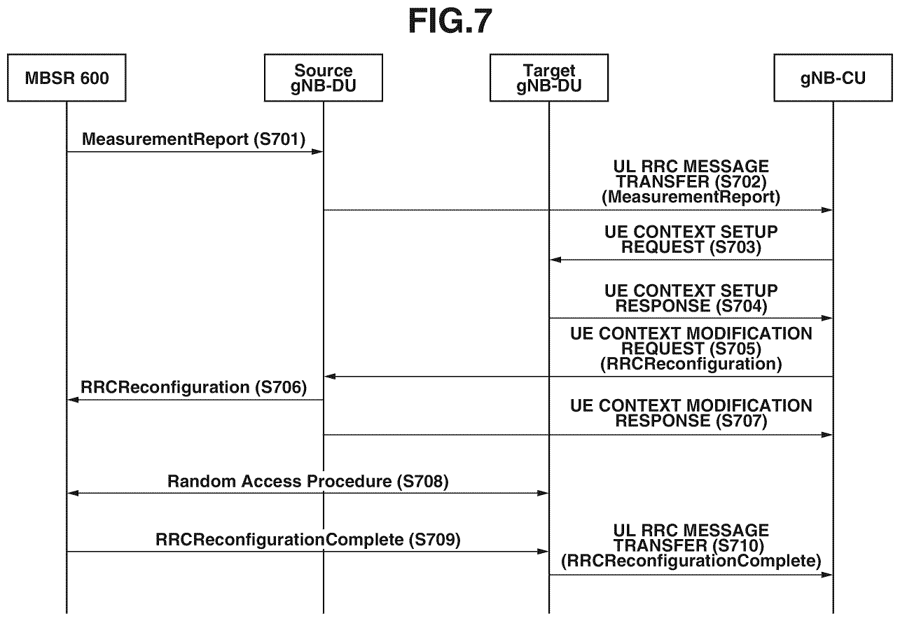

FIG. 7 illustrates a sequence when the MBSR 600 moves, and a connection destination is changed from a source base station (Source gNB-DU) to a target base station (Target gNB-DU). At this time, it is assumed that the two gNB-DUs are present in a single gNB-CU. Since the sequence itself is the same as the sequence defined in TS 38.401, Clause 8.2.1.1, detailed description of each message is omitted. Only portions that are key points in the present embodiment are described.

First, in step S701, the MBSR 600 notifies the Source gNB-DU of a MeasurementReport. In the present embodiment, the MBSR 600 includes MBSR status information in the message. The MBSR status information is similar to the MBSR status information described in the second embodiment. The MBSR 600 updates the MBSR status information based on the current state and notifies the base station of the MBSR status information. This enables the base station to know the latest state of the notified MBSR and to update the permitted area information to be notified based on the latest state of the MBSR.

In step S702, the Source gNB-DU transmits the received MeasurementReport as UL RRC MESSAGE TRANSFER to the gNB-CU.

The gNB-CU selects permitted area information based on the received MBSR status information. In a case where the gNB-DU to which the MBSR is connected is changed as in the present embodiment, the gNB-CU selects the permitted area information corresponding to the MBSR status information based on the target base station (Target gNB-DU).

In step S705, the gNB-CU generates an RRCReconfiguration message including the selected permitted area information, and transmits the RRCReconfiguration message as UE CONTEXT MODIFICATION REQUEST to the Source gNB-DU. In step S706, the RRCReconfiguration message is notified from the Source gNB-DU to the MBSR 600. The MBSR 600 performs RRC reconfiguration and updating of the permitted area information based on the received RRCReconfiguration message.

Next, processing when the base station (gNB-CU, Source gNB-DU, or Target gNB-DU) updates and notifies the permitted area information is described with reference to a flowchart.

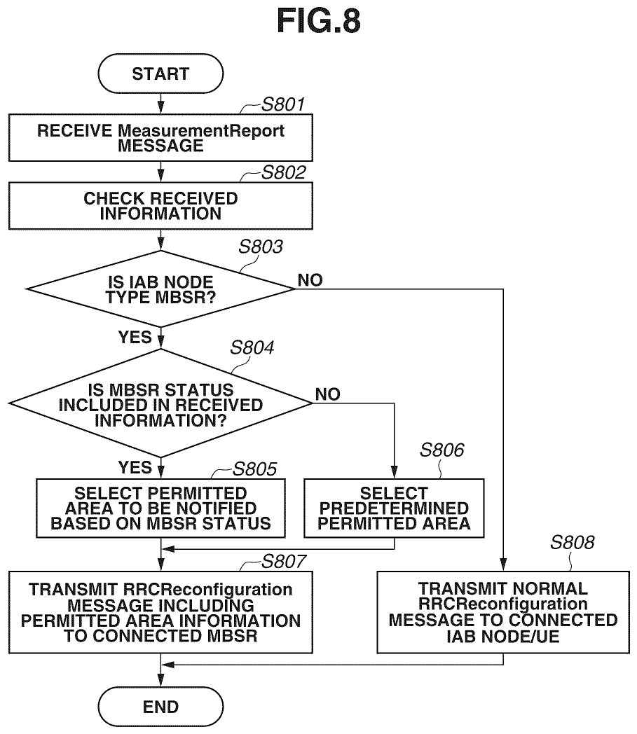

FIG. 8 illustrates a flow of RRC reconfiguration processing (connection reconfiguration processing) by the base station according to the present embodiment.

In step S801, the base station receives a MeasurementReport message transmitted by the MBSR 600.

In step S802, the base station analyzes the received MeasurementReport message, and checks information included in the message.

In step S803, the base station determines whether the opposite communication apparatus is an MBSR. In the determination, the IAB node type information received at the time of initial connection may be used, or the IAB node type information may be included in the MeasurementReport message. In a case where the opposite communication apparatus is not an MBSR (NO in step S803), the processing proceeds to step S808. In step S808, a normal RRCReconfiguration message not including the permitted area information is transmitted to the opposite communication apparatus, and the processing then ends. In a case where the opposite communication apparatus is an MBSR (YES in step S803), the processing proceeds to step S804.

In step S804, the base station checks whether MBSR status information is included in the received information. In a case where MBSR status information is included in the received information (YES in step S804), the processing proceeds to step S805. In step S805, the base station selects permitted area information to be notified to the MBSR based on the status of the MBSR. A selection method is similar to the selection method according to the second embodiment. At this time, in a case where the MBSR switches to another base station (i.e., in a case where the MBSR changes the base station to be connected), the permitted area information is selected in consideration of a position of the base station to be connected. After the permitted area information to be notified is selected, the processing proceeds to step S807. In a case where the MBSR status information is not included in the received information (NO in step S804), the processing proceeds to step S806. In step S806, predetermined permitted area information is selected, and the processing proceeds to step S807. Also at this time, in the case where the MBSR switches to another base station, the predetermined permitted area information on the other base station to be connected is selected.

In step S807, the base station generates an RRCReconfiguration message including the permitted area information selected in step S805 or S806, and transmits the RRCReconfiguration message to the opposite communication apparatus.

Although the embodiments have been described in detail above, the embodiments are not limited to the specific embodiments, and various modifications and changes can be made within the scope described in the claims. Furthermore, it is also possible to combine all or some of the constituent elements of the aforementioned embodiments.

After the processing procedure in step S303 or S305 of FIG. 3 is completed, the gNB 300 and the MBSR 600 perform an F1 establishment procedure. Specifically, the MBSR 600 transmits an F1 Setup Request to the gNB 300, and the gNB 300 transmits an F1 Setup Response to the MBSR 600. Thus, the gNB 300 may include the permitted area information in the F1 Setup Response in place of an RRC message and transmit the F1 Setup Response to the MBSR 600.

Furthermore, the following supplementary disclosures are provided with respect to the above embodiments.

### Supplementary Disclosure 1

A communication apparatus comprising:
a first acquisition unit configured to acquire type information enabling determination as to whether another communication apparatus is an Integrated Access and Backhaul (IAB) node of a first type involving mobility;
a generation or acquisition unit configured to generate or acquire area information about an area where the IAB node of the first type provides service;
   a determination unit configured to determine whether to notify the other communication apparatus of the area information based on the type information on the other communication apparatus; and
   a transmission unit configured to transmit the area information to the other communication apparatus based on a determination result of the determination unit.

### Supplementary Disclosure 2

The communication apparatus according to Supplementary Disclosure 1, wherein the transmission unit transmits the area information by using a Radio Resource Control (RRC) message.

### Supplementary Disclosure 3

The communication apparatus according to Supplementary Disclosure 1 or 2, wherein the RRC message is an RRCReconfiguration message or an RRCSetup message.

### Supplementary Disclosure 4

The communication apparatus according to any one of Supplementary Disclosures 1 to 3, wherein the type information is acquired by using notification information or the RRC message.

### Supplementary Disclosure 5

The communication apparatus according to any one of Supplementary Disclosures 2 and 3, wherein the RRC message is an RRCSetupComplete message.

### Supplementary Disclosure 6

The communication apparatus according to any one of Supplementary Disclosures 1 to 5, wherein the transmission unit transmits the area information to the other communication apparatus in a case where the determination unit determines that the other communication apparatus is the IAB node of the first type based on the type information on the other communication apparatus.

### Supplementary Disclosure 7

The communication apparatus according to Supplementary Disclosure 6, wherein the transmission unit does not transmit the area information to the other communication apparatus in a case where the determination unit determines, based on the type information on the other communication apparatus, that the other communication apparatus is an IAB node of a second type not involving mobility or a User Equipment (UE).

### Supplementary Disclosure 8

The communication apparatus according to any one of Supplementary Disclosures 1 to 7, wherein the generation or acquisition unit is configured to generate or acquire the area information based on position information of an own apparatus.

### Supplementary Disclosure 9

The communication apparatus according to Supplementary Disclosure 8, wherein the area relating to the area information is located around the own apparatus.

### Supplementary Disclosure 10

The communication apparatus according to any one of Supplementary Disclosures 1 to 9, further comprising:
a second acquisition unit configured to acquire area group information about a plurality of permitted areas forming the area from a Core Network (CN); and
a selection unit configured to select one or more permitted areas relating to the area information to be notified to the other communication apparatus from among the plurality of permitted areas.

### Supplementary Disclosure 11

The communication apparatus according to Supplementary Disclosure 10, further comprising a third acquisition unit configured to acquire state information about a state of the other communication apparatus having the type information indicating the IAB node of the first type, wherein the selection unit selects the one or more permitted areas based on the state information.

### Supplementary Disclosure 12

The communication apparatus according to Supplementary Disclosure 11, wherein the state indicated by the state information relates to movement of the other communication apparatus.

### Supplementary Disclosure 13

The communication apparatus according to any one of Supplementary Disclosures 11 or 12, wherein the state indicated by the state information includes at least one or more of a current position, a movement speed, a movement direction, a stop time, a scheduled stop time, a planned movement path, and an operation route.

### Supplementary Disclosure 14

The communication apparatus according to any one of Supplementary Disclosures 11 to 13, wherein the third acquisition unit acquires the state information by a MeasurementReport.

### Other Embodiments

The present disclosure can also be realized by supplying a program that implements one or more functions of the above-described embodiments to a system or apparatus via a network or a storage medium, and causing one or more processors in a computer of the system or apparatus to read and execute the program. Furthermore, the present disclosure can also be realized by a circuit, such as an application-specific integrated circuit (ASIC) or a field-programmable gate array (FPGA), that implements the one or more functions.

The present disclosure is not limited to the above-described embodiments, and various modifications and variations can be made without departing from the spirit and scope of the present disclosure. Accordingly, the following claims are appended to publicly indicate the scope of the present disclosure.

According to one aspect of the present disclosure, it is possible to provide the mechanism that can efficiently notify the MBSR of the permitted area information.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus comprising:
a first acquisition unit configured to acquire type information enabling determination as to whether another communication apparatus is an Integrated Access and Backhaul (IAB) node of a first type involving mobility;
a storage unit configured to store generated or acquired area information about an area where the IAB node of the first type provides service;
a determination unit configured to determine whether to notify the other communication apparatus of the area information based on the type information on the other communication apparatus; and
a transmission unit configured to transmit the area information to the other communication apparatus based on a determination result of the determination unit.

2. The communication apparatus according to claim 1, wherein the transmission unit transmits the area information by using a Radio Resource Control (RRC) message.

3. The communication apparatus according to claim 2, wherein the RRC message is an RRCReconfiguration message or an RRCSetup message.

4. The communication apparatus according to claim 1, wherein the first acquisition unit acquires the type information by using notification information or an RRC message.

5. The communication apparatus according to claim 4, wherein the RRC message is an RRCSetupComplete message.

6. The communication apparatus according to claim 1, wherein the transmission unit transmits the area information to the other communication apparatus in a case where the determination unit determines that the other communication apparatus is the IAB node of the first type based on the type information on the other communication apparatus.

7. The communication apparatus according to claim 6, wherein the transmission unit does not transmit the area information to the other communication apparatus in a case where the determination unit determines, based on the type information on the other communication apparatus, that the other communication apparatus is an IAB node of a second type not involving mobility or a User Equipment (UE).

8. The communication apparatus according to claim 1, wherein the storage unit stores the area information generated by an own apparatus based on position information on the own apparatus, or area information generated by an external apparatus based on the position information on the own apparatus and acquired from outside.

9. The communication apparatus according to claim 8, wherein the area relating to the area information is an area located around the own apparatus.

10. The communication apparatus according to claim 1, further comprising:
a second acquisition unit configured to acquire area group information about a plurality of permitted areas forming the area from a Core Network (CN); and
a selection unit configured to select one or more permitted areas relating to the area information to be notified to the other communication apparatus from among the plurality of permitted areas indicated by the area group information,
wherein the storage unit stores the permitted areas selected by the selection unit.

11. The communication apparatus according to claim 10, further comprising a third acquisition unit configured to acquire state information about a state of the other communication apparatus having the type information indicating the IAB node of the first type,
wherein the selection unit selects the one or more permitted areas based on the state information.

12. The communication apparatus according to claim 11, wherein the state indicated by the state information relates to movement of the other communication apparatus.

13. The communication apparatus according to claim 12, wherein the state indicated by the state information includes at least one or more of a current position, a movement speed, a movement direction, a stop time, a scheduled stop time, a planned movement path, and an operation route.

14. The communication apparatus according to claim 11, wherein the third acquisition unit acquires the state information by a MeasurementReport.

15. A method for controlling communication, the method comprising:
acquiring type information enabling determination as to whether another communication apparatus is an Integrated Access and Backhaul (IAB) node of a first type involving mobility;
generating or acquiring area information about an area where the IAB node of the first type provides service and storing the area information in a predetermined storage area;
determining whether to notify the other communication apparatus of the area information based on the type information on the other communication apparatus; and
transmitting the area information to the other communication apparatus based on a determination result in the determining.

16. A non-transitory computer-readable storage medium storing a program for causing a computer to execute:
acquiring type information enabling determination as to whether another communication apparatus is an Integrated Access and Backhaul (IAB) node of a first type involving mobility;
generating or acquiring area information about an area where the IAB node of the first type provides service and storing the area information in a predetermined storage area;
determining whether to notify the other communication apparatus of the area information based on the type information on the other communication apparatus; and
transmitting the area information to the other communication apparatus based on a determination result in the determining.
